(19) United States
(12) Patent Application Publication
(10) Pub. No.: US 2014/0361950 A1
(43) Pub. Date: Dec. 11, 2014

(54) ANTENNA STRUCTURE AND WIRELESS COMMUNICATION DEVICE EMPOLYING SAME

(71) Applicant: FIH (Hong Kong) Limited, Kowloon (HK)

(72) Inventors: CHAO-WEI HO, New Taipei (TW); CHI-SHENG LIU, New Taipei (TW); PAI-CHENG HUANG, New Taipei (TW); CHIH-YANG TSAI, New Taipei (TW); CHUAN-CHOU CHI, New Taipei (TW); HAO-YING CHANG, New Taipei (TW)

(73) Assignee: FIH (HONG KONG) LIMITED, Kowloon (HK)

(21) Appl. No.: 14/228,612

(22) Filed: Mar. 28, 2014

(30) Foreign Application Priority Data
Jun. 5, 2013 (TW) 102120015

(51) Int. Cl. H01Q 21/30

(52) U.S. Cl. CPC H01Q 21/30
USPC 343/893

(57) ABSTRACT

An antenna structure includes a main antenna and a diversity antenna spaced apart from the main antenna. The main antenna extends in a main antenna radiation direction. The diversity antenna includes a first radiation portion extending in a first radiation direction and a second radiation portion extending in a second radiation direction, the first radiation direction is substantially perpendicular to either the second radiation direction or an the main antenna radiation direction.

### FIELD

The exemplary disclosure generally relates to antennas, and particularly to a antenna structure using multi-input multi-output (MIMO) technique and a wireless communication device employing same.

### BACKGROUND

An MIMO antenna technology uses two or more antennas (usually including a main antenna and a diversity antenna) at each base station and mobile communication terminal in carrying data and receiving and detecting signals. Accordingly, an MIMO antenna system improves the transmission reliability and overcomes the limitations in transmission rate confronted by the expansion of data communication. Radiation efficiency, isolation, and envelope correlation coefficient (ECC) are important parameters for measurement of the performance of the MIMO antenna system. Usually, a high isolation and low ECC of the MIMO antenna system are required.

The MIMO antenna system usually includes a main antenna and a diversity antenna. However, a mobile communication terminal with the MIMO antenna system can experience the mutual coupling between antennas due to the spatial limitation of the mobile communication terminal, resulting in reduced isolation and increased ECC between the main antenna and the diversity antenna.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 is a view of an exemplary embodiment of a wireless communication device employing an antenna structure.

FIG. 2 is similar to FIG. 1, but showing the wireless communication device in another view angle.

### DETAILED DESCRIPTION

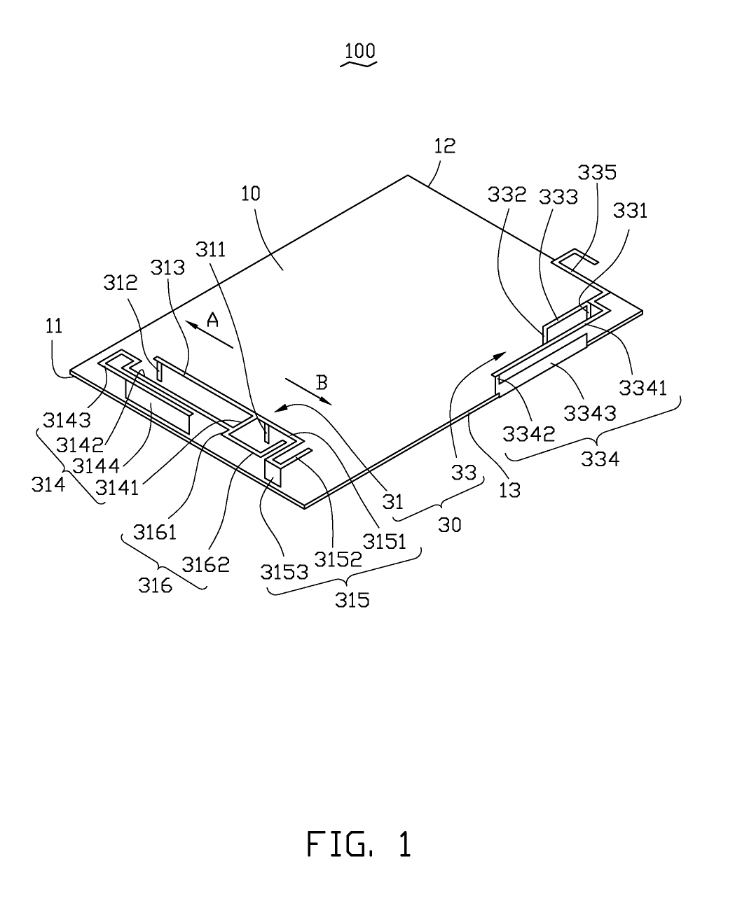

FIG. 1 shows an exemplary embodiment of a wireless communication device 100 including a printed circuit board (PCB) 10 and an antenna structure 30 mounted on the PCB 10. The antenna structure 30 includes a main antenna 31 and a diversity antenna 33. The main antenna 31 can receive/send wireless signals having the same frequency band as wireless signals received/sent by the diversity antenna 33.

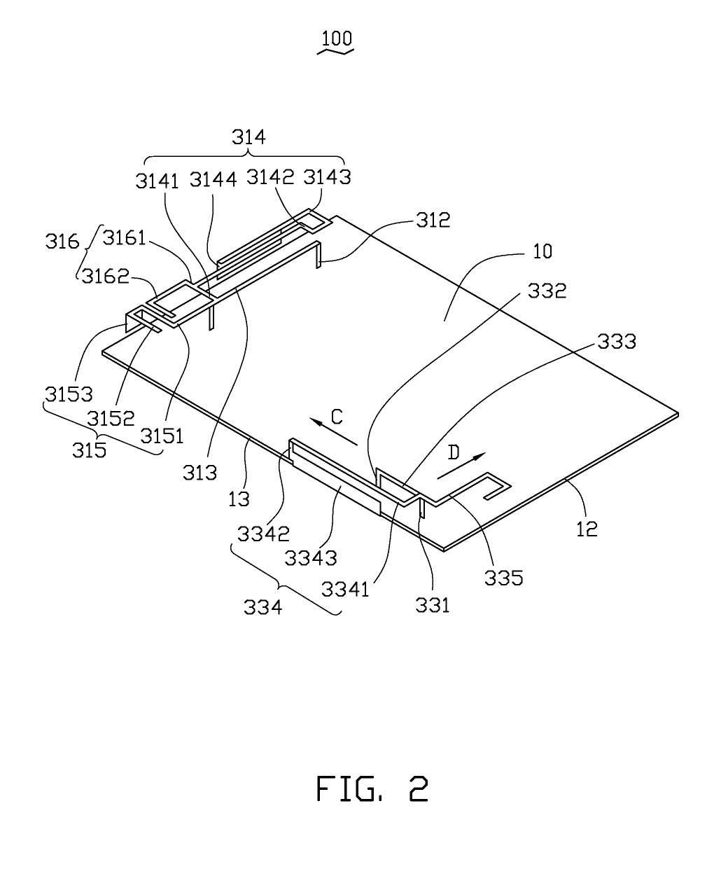

FIG. 2 shows the same exemplary embodiment of wireless communication device of FIG. 1 in another view angle. The PCB 10 includes a first side 11 (shown in FIG. 1), a second side 12 (shown in FIG. 2), and a third side 13 (shown in FIG. 1). The first side 11 is substantially parallel to the second side 12, and the third side 13 is substantially perpendicular to either the first side 11 or the second side 12. In the exemplary embodiment, the PCB 10 is a substantially rectangular board, the first and second sides 11 and 12 are a pair of short sides of the PCB 10, and the third side 13 is one of two long sides of the PCB 10.

The main antenna 31 is positioned at the first side 11 of the PCB 10, and extends in a main antenna direction. In the exemplary embodiment, the main antenna 31 includes a feeding arm 311, a grounding arm 312, a connecting arm 313, a first branch 314, a second branch 315, and a third branch 316. The feeding arm 311 is electronically coupled to and positioned substantially perpendicular to the PCB 10, for feeding current signal. The grounding arm 312 is electronically coupled to and positioned substantially perpendicular to the PCB 10, to be grounded via the PCB 10. The grounding arm 312 is substantially parallel to and spaced apart from the feeding arm 311. The grounding arm 312 and the feeding arm 311 are positioned in the same plane with the first side 11. The connecting arm 313 is connected between the feeding arm 311 and the grounding arm 312, and is positioned in a plane that is substantially perpendicular to a plane in which the feeding arm 311 and the grounding arm 312 are positioned. An impedance matching of the main antenna 31 can be adjusted by adjusting a length of the connecting arm 313, that is, a distance between the feeding arm 311 and the grounding arm 312.

All of the first, second, and third branches 314, 315, and 316 extend from the feeding arm 311. In general, the first branch 314 extends from the feeding arm 311 along a first direction A, the second and the third branches 315 and 316 both extend from the feeding arm 311 along a second direction B opposite to the first direction A. The first and the second directions are substantially parallel to the first side 11 of the PCB 10. In the exemplary embodiment, all of the first, second, and third branches 314, 315, and 316 are metallic meander strips. When the current signal is fed to the feeding arm 311, the a first current path is formed on the first branch 314 to generate a resonate mode to receive/send wireless signals at a low-frequency band of about 791-960 MHz. A second current path is formed on the second branch 315 to generate a resonate mode to receive/send wireless signals at a first high-frequency band of about 2500-2692 MHz. In addition, a third current path is formed on the third branch 316 to generate a resonate mode to receive/send wireless signals at a second high-frequency band of about 1710-2170 MHz.

In the exemplary embodiment, the first branch 314 includes a first radiating arm 3141, a second radiating arm 3142, a third radiating arm 3143, and a first metal sheet 3144, all of which are connected in series. The first, second, and third radiating arms 3141, 3142, and 3143 are coplanar with the connecting arm 313. The first radiating arm 3141 substantially perpendicularly extends from the connecting arm 313 adjacent to a junction between the connecting arm 313 and the feeding arm 311. The second radiating arm 3142 and the connecting arm 313 are positioned at the same side of the first radiating arm 3141. The second radiating arm 3142 substantially perpendicularly extends from the first radiating arm 3142 to be parallel to the connecting arm 413, then substantially perpendicularly extends towards the connecting arm 313, and then substantially perpendicularly extends away from the first radiating arm 3141. The third radiating arm 3143 is a substantially L-shaped strip. The third radiating arm 3143 substantially perpendicularly extends from an end of the second radiating arm 3142, and then substantially perpendicularly extends towards the first radiating arm 3141 to be substantially parallel with the connecting arm 313. The third radiating arm 3143 and the connecting arm 313 are respectively positioned at two opposite sides of the second radiating arm 3142. The first metal sheet 3144 is a substantially rectangular sheet, and substantially perpendicularly extends from an outer side of a distal end of the third radiating arm 3143. The first metal sheet 3144 is positioned in a plane that is substantially perpendicular to a plane in which the third radiating arm 3143 is positioned. A width of the first metal sheet 3144 is greater than (such as three times) a width of the third radiating arm 3143.

The second branch 315 includes a fourth radiating arm 3153, a fifth radiating arm 3152, and a second metal sheet 3153. The fourth radiating arm 3153 and the fifth radiating arm 3152 are coplanar with the connecting arm 313. The fourth radiating arm 3151 extends from the junction between the connecting arm 313 and the feeding arm 311 away from the connecting arm 313. In other words, the fourth radiating arm 3151 is collinear with the connecting arm 313. The fifth radiating arm 3152 is a substantially U-shaped strip. The fifth radiating arm 3152 and the first branch 313 are positioned at the same side of the connecting arm 313. The second metal sheet 3153 substantially perpendicularly extends from a side of the fifth radiating arm 3153 opposite to the fourth radiating arm 3154. The second metal sheet is a substantially rectangular sheet, and is positioned in a plane that is substantially perpendicularly to a plane in which the fifth radiating arm 3152 is positioned. A width of the second metal sheet 3153 is greater than (such as three times of) a width of the fifth radiating arm 3152.

The third branch 316 shares the first radiating arm 3141 with the first branch 314, and further includes a sixth radiating arm 3161 and a seventh radiating arm 3141 extending from the sixth radiating arm 3161. The sixth radiating arm 3161 extends from a distal end of the first radiating arm 3141. The seventh radiating arm 3162 is a substantially L-shaped strip, and substantially perpendicularly extends from the sixth radiating arm 3161 towards the fifth radiating arm 3152, and then perpendicularly extends toward the fourth radiating arm 3151.

The diversity antenna includes a feeding arm 331, a grounding arm 332, a connecting arm 333, a first radiating portion 334, and a second radiating portion 335. The feeding arm 331 is electronically connected to and positioned substantially perpendicular to the PCB 10 to feed current signal. The grounding arm 332 is electronically connected to and positioned substantially perpendicular to the PCB 10 to be grounded via the PCB 10. The grounding arm 332 is substantially parallel to and spaced apart from the feeding arm 331. The connecting arm 333 is connected between the grounding arm 332 and the feeding arm 331, and is perpendicular to either the feeding arm 331 or the grounding arm 332. The feeding arm 331, the grounding arm 332, and the connecting arm 333 are positioned in a plane that is perpendicular to a plane in which the PCB 10 is positioned. An impedance matching of the diversity antenna 30 can be adjusted by adjusting a length of the connecting arm 333, that is, the distance between the grounding arm 332 and the feeding arm 331.

The first radiating portion 334 and the second radiating portion 335 extend from the feeding arm 331. In general, the first radiating portion 334 extends from the feeding arm 331 along a third direction C parallel with the third side 13 of the PCB 10. In addition, the second radiating portion 335 extends from the feeding arm 335 along a fourth direction D substantially perpendicular to the third direction C and parallel to the second side 12 of the PCB 10. The first radiating portion 334 and the second radiating portion 335 are metallic meander strips. When the current signal is fed to the feeding arm 331, a fourth current path is formed on the first radiating portion to generate a resonate mode to receive/send wireless signals at the low-frequency band of about 791-960 MHz. In addition, a fifth current path is formed on the second radiating portion to generate a resonate mode to receive/send wireless signals at a high-frequency band of about 1710-2690 MHz.

In the illustrated embodiment, the first radiating portion 334 includes a first resonating arm 3341, a second resonating arm 3342, and a third metal sheet 3343. The first resonating arm 3341 is a substantially L-shaped strip. The first resonating arm 3341 extends from a junction between the feeding arm 331 and the connecting arm 333 to be substantially perpendicular to the connecting arm 333, and then perpendicularly extends to be parallel with the connecting arm 333. The second resonating arm 3342 is substantially a rectangular strip, and substantially perpendicularly extends from a distal end of the first resonating arm 3341 towards the PCB 10. The third metal sheet 3343 is a substantially rectangular sheet, and substantially perpendicularly extends from an end of the second resonating arm 3342 towards the feeding arm 331. The third metal sheet 3343 and the second resonating arm 3342 are both positioned in a plane that is parallel with a plane in which the feeding arm 331 and the grounding arm 332 are positioned. A width of the third metal sheet 3343 is greater than (such as three times) a width of the second resonating arm 3342.

The second radiating portion 335 is coplanar with the first resonating arm 3341. The second radiating portion 335 extends from the junction between the feeding arm 331 and the connecting arm 333 away from the connecting arm 333, then perpendicularly extends along the fourth direction D, and then substantially perpendicularly extends along a direction opposite to the direction C, finally, substantially perpendicularly extends along a direction opposite to the direction D.

The main antenna 31 is positioned along the first side 11 of the PCB 10, the first radiating portion 334 of the diversity antenna 33 is positioned along the third side 13 of the PCB 10, and the second radiating portion 335 is positioned along the second side 12 of the PCB 10. In other words, the first radiating portion 334 extends in a first radiation direction substantially perpendicular to the main antenna radiation direction of the main antenna 31, and the second radiating portion 335 extends in a second radiation direction parallel to the main antenna radiation direction of the main antenna 31. Thus, a radiation direction of the first radiating portion 334 is different from a radiating direction of the main antenna 31, thereby a high isolation and low ECC can be achieved. In addition, the connecting arm 313 connecting the feeding arm 311 and the grounding arm 312 is parallel with the first side 11 of the PCB 10. The connecting arm 333 connecting the feeding arm 331 and the grounding arm 332 is parallel with the third side 13 of the PCB 10, thus the connecting arm 313 of the main antenna 31 is substantially perpendicular to the connecting arm 333 of the diversity antenna 33. Such that, when current signals are fed to the feeding arm 311 of the main antenna 31 and the feeding arm 313 of the diversity antenna 33, a direction of a grounding path of the current signal flowing through the main antenna 31 is different from a direction of a grounding path of the current signal flowing through the diversity antenna 33, which further causes a increase of the isolation and a decrease of the ECC between the main antenna 31 and the diversity antenna 33.

Table 1 shows ECC values of the antenna structure 30 at a sample frequency band of about 791-890 MHz (LTE). As shown in Table 1, the ECC values between the main antenna 31 and the diversity antenna 33 are all less than 0.5 at each sample frequency, thus the antenna structure 30 can achieve an approving transmission performance.

TABLE 1

| | Frequency (MHz) | | | | | |
|---|---|---|---|---|---|---|
| | 796 | 806 | 816 | 874 | 881.5 | 889 |
| ECC | 0.3857 | 0.3658 | 0.3509 | 0.3018 | 0.2631 | 0.2541 |

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An antenna structure, comprising:
a main antenna extending in a main antenna radiation direction; and
a diversity antenna spaced apart from the main antenna, the diversity antenna having a first radiation portion extending in a first radiation direction and a second radiation portion extending in a second radiation direction, wherein the first radiation direction is substantially perpendicular to either the second radiation direction or the main antenna radiation direction.

2. The antenna structure of claim 1, wherein the main antenna comprises a first grounding arm, a first feeding arm, and a first connecting arm connected between the first grounding arm and the first feeding arm; the diversity antenna comprises a second grounding arm, a second feeding arm, and a second connecting arm connected between the second feeding arm and the second grounding arm; the first connecting arm is perpendicular to the second connecting arm.

3. The antenna structure of claim 2, wherein the main antenna further comprises a first branch, a second branch, and a third branch, all of which extend from the first feeding arm; when a current signal is fed to the first feeding arm, a first current path is formed on the first branch to generate a resonate mode at a first low frequency band, a second current path is formed on the second branch to generate a resonate mode at a first high frequency band, and a third current path is formed on the third branch to generate a resonate mode at a second high frequency band.

4. The antenna structure of claim 3, wherein all of the first branch, the second branch, and the third branch are metallic meander strips.

5. The antenna structure of claim 3, wherein the first branch comprises a first radiating arm, a second radiating arm, and a third radiating arm, all of which are connected in series and are coplanar with each other; the first radiating arm substantially perpendicularly extends from the first connecting arm away from the first feeding arm; the third radiating arm is substantially a L-shaped strip; the third radiating arm substantially perpendicularly extends from an end of the second radiating arm, and then perpendicularly extends towards the first radiating arm to be parallel with the first connecting arm.

6. The antenna structure of claim 3, wherein the second branch comprises a fourth radiating arm and a fifth radiating arm connecting to the fourth radiating arm, the fourth radiating arm extends from a junction between the first connecting arm and the first feeding arm away from the first connecting arm; the fifth radiating arm is a substantially U-shaped strip; the fifth radiating arm and the first branch are positioned at the same side of the first connecting arm.

7. The antenna structure of claim 5, wherein the third branch shares the first radiating arm with the first branch, and further comprises a sixth radiating arm and a seventh radiating arm extending from the sixth radiating arm; the sixth radiating arm extends from a distal end of the first radiating arm; the seventh radiating arm is a substantially L-shaped strip.

8. The antenna structure of claim 2, therein the first radiating portion and the second radiating portion both are metallic meander strips, and both extends from the second feeding arm; when a current signal is fed to the feeding arm, a first current path is formed on the first radiating portion to generate a resonate mode to receive/send wireless signals at a low-frequency band; and a second current path is formed on the second radiating portion to generate a resonate mode to receive/send wireless signals at a high-frequency band.

9. The antenna structure of claim 8, wherein the first radiating portion comprise a first resonating arm, and a second resonating arm; the first resonating arm is a substantially L-shaped strip, the first resonating arm extends from a junction between the second feeding arm and the second connecting arm to be substantially perpendicular to the second connecting arm, and then perpendicularly extends to be parallel with the second connecting arm; the second resonating arm substantially perpendicularly extends from a distal end of the first resonating arm.

10. A wireless communication device, comprising:
a printed circuit board (PCB) comprising a first side, a second side parallel to the first side, and a third side perpendicularly connected between the first side and the second side; and
an antenna structure mounted on the PCB, the antenna structure comprising:
a main antenna positioned along the first side and extending in a main antenna radiation direction; and
a diversity antenna spaced apart from the main antenna, wherein the diversity antenna having a first radiation portion and a second radiation portion, the first radiation portion positioned along the third side and extending in a first radiating direction, the second radiation portion positioned along the second side and extending along a second radiation direction, wherein the first radiation direction is substantially perpendicular to either the second radiation directing or an the main antenna radiation direction.

11. The wireless communication device of claim 10, wherein the main antenna comprises a first grounding arm, a first feeding arm, and a first connecting arm connected between the first grounding arm and the first feeding arm; the diversity antenna comprises a second grounding arm, a second feeding arm, and a second connecting arm connected between the second feeding arm and the second grounding arm; the first connecting arm is perpendicular to the second connecting arm.

12. The wireless communication device of claim 11, wherein the main antenna further comprises a first branch, a second branch, and a third branch, all of which extend from the first feeding arm; when a current signal is fed to the first feeding arm, a first current path is formed on the first branch to generate a resonate mode at a first low frequency band, a second current path is formed on the second branch to generate a resonate mode at a first high frequency band, and a third current path is formed on the third branch to generate a resonate mode at a second high frequency band.

13. The wireless communication device of claim 12, wherein all of the first branch, the second branch, and the third branch are metallic meander strips.

14. The wireless communication device of claim 12, wherein the first branch comprises a first radiating arm, a second radiating arm, and a third radiating arm, all of which are connected in series and are coplanar with each other; the first radiating arm substantially perpendicularly extends from the first connecting arm away from the first feeding arm; the third radiating arm is substantially a L-shaped strip; the third radiating arm substantially perpendicularly extends from an end of the second radiating arm, and then perpendicularly extends towards the first radiating arm to be parallel with the first connecting arm.

15. The wireless communication device of claim 12, wherein the second branch comprises a fourth radiating arm and a fifth radiating arm connecting to the fourth radiating arm, the fourth radiating arm extends from a junction between the first connecting arm and the first feeding arm away from the first connecting arm; the fifth radiating arm is a substantially U-shaped strip; the fifth radiating arm and the first branch are positioned at the same side of the first connecting arm.

16. The wireless communication device of claim 14, wherein the third branch shares the first radiating arm with the first branch, and further comprises a sixth radiating arm and a seventh radiating arm extending from the sixth radiating arm; the sixth radiating arm extends from a distal end of the first radiating arm; the seventh radiating arm is a substantially L-shaped strip.

17. The wireless communication device of claim 11, therein the first radiating portion and the second radiating portion both are metallic meander strips, and both extends from the second feeding arm; when a current signal is fed to the feeding arm, a first current path is formed on the first radiating portion to generate a resonate mode to receive/send wireless signals at a low-frequency band; and a second current path is formed on the second radiating portion to generate a resonate mode to receive/send wireless signals at a high-frequency band.

18. The wireless communication device of claim 17, wherein the first radiating portion comprise a first resonating arm, and a second resonating arm; the first resonating arm is a substantially L-shaped strip, the first resonating arm extends from a junction between the second feeding arm and the second connecting arm to be substantially perpendicular to the second connecting arm, and then perpendicularly extends to be parallel with the second connecting arm; the second resonating arm substantially perpendicularly extends from a distal end of the first resonating arm.
